(19) United States
(12) Patent Application Publication
(10) Pub. No.: US 2014/0279660 A1
(43) Pub. Date: Sep. 18, 2014

(54) OVERNIGHT PRODUCTIVITY DASHBOARD

(71) Applicants: Aaron Santavicca, Bentonville, AR (US); James William Burgmeier, Bentonville, AR (US); Jeffrey Scott Cruz, Bentonville, AR (US); Marsha Talmadge David, Rogers, AR (US); John L. Sokolsky, Bentonville, AR (US); Walter King Wilson, IV, Carl Junction, MO (US); Justin Lynn Brandon, Bentonville, AR (US)

(72) Inventors: Aaron Santavicca, Bentonville, AR (US); James William Burgmeier, Bentonville, AR (US); Jeffrey Scott Cruz, Bentonville, AR (US); Marsha Talmadge David, Rogers, AR (US); John L. Sokolsky, Bentonville, AR (US); Walter King Wilson, IV, Carl Junction, MO (US); Justin Lynn Brandon, Bentonville, AR (US)

(73) Assignee: Wal-Mart Stores, Inc., Bentonville, AR (US)

(21) Appl. No.: 13/918,445

(22) Filed: Jun. 14, 2013

Related U.S. Application Data
(60) Provisional application No. 61/798,013, filed on Mar. 15, 2013.

(51) Int. Cl. G06Q 10/08

(52) U.S. Cl. CPC G06Q 10/083
USPC 705/337

(57) ABSTRACT

A freight processing system includes a programmable processor, and a memory operatively coupled to the processor. The memory has stored thereon computer-executable instructions that when executed by the processor cause the processor to access a database holding freight data representing each of a plurality of freight units scheduled to be shipped to a receiving site in a single truck load, the database being operatively coupled to the processor, assess the freight data using a set of business rules, assign a priority to each of the freight units based at least in part on the assessment of the freight data, calculate a workload estimate representing an amount of time to be allocated for processing all of the freight units at the receiving site based at least in part on the set of business rules, and generate report data representing: the priority assigned to each respective freight unit, and the workload estimate.

### RELATED APPLICATIONS

This application claims priority under 35 U.S.C. §119(e) to U.S. Provisional Patent Application Ser. No. 61/798,013, entitled “Overnight Productivity Dashboard,” filed on Mar. 15, 2013, which is hereby incorporated by reference in its entirety.

### BACKGROUND

Embodiments of the disclosure are related generally to data processing, and more particularly to methods and systems for automatically planning for the receiving of freight, automatically generating freight unload plans, and automatically collecting data for quality assurance auditing.

In the retail industry, merchandise is often shipped by truck from distribution centers or warehouses to stores, sometimes on a daily basis or other regular schedule. In some instances, a wide variety of merchandise destined for a particular store can be consolidated into a single load of freight. For example, a single load of freight may include many different items, e.g., housewares, groceries, clothing, electronics, etc., having different sizes, weights and packaging, which upon delivery are to be unloaded from the truck and stocked or warehoused in different locations around the store.

Receiving a consolidated load of freight can be labor intensive and time consuming, as all of the merchandise must be identified and appropriately handled as it is unloaded. Furthermore, the time and/or labor resources needed to receive the freight can vary from load to load, depending on the composition of each load, which may not be known until the freight has been shipped.

### SUMMARY

According to an embodiment, a computer-implemented method of processing freight data includes electronically accessing a database holding freight data representing each of a plurality of freight units scheduled to be shipped to a receiving site in a single truck load, electronically assessing the freight data using a set of business rules, electronically assigning a priority to each of the freight units based the assessment of the freight data, electronically calculating a workload estimate representing an amount of time to be allocated for processing all of the freight units at the receiving site based at least in part on the set of business rules, and electronically generating report data representing: the priority assigned to each respective freight unit, and the workload estimate.

In some embodiments, the method may include assigning the priority based at least in part on a sequence in which the respective freight unit is to be processed at the receiving site, and further calculating the workload estimate based at least in part on the priority. In some embodiments, the method may include calculating the workload estimate based at least in part on an allocation of labor resources to be used for processing the respective freight unit at the receiving site, and further assigning the priority based at least in part on the workload estimate.

In some embodiments, the step of assigning the priority may include assigning the priority based at least in part on a size of the respective freight unit. In some embodiments, the priority assigned to the respective freight unit may be higher than the priority assigned to another freight unit having a smaller size than the respective freight unit. In some embodiments, the workload estimate may be based at least in part on historical data representing amounts of time previously utilized for processing freight units at the receiving site. In some embodiments, the method may include providing an application configured to display at least some of the report data via a user interface.

According to an embodiment, a freight processing system includes a programmable processor, and a memory operatively coupled to the processor. The memory has stored thereon computer-executable instructions that when executed by the processor cause the processor to access a database holding freight data representing each of a plurality of freight units scheduled to be shipped to a receiving site in a single truck load, the database being operatively coupled to the processor, assess the freight data using a set of business rules, assign a priority to each of the freight units based at least in part on the assessment of the freight data, calculate a workload estimate representing an amount of time to be allocated for processing all of the freight units at the receiving site based at least in part on the set of business rules, and generate report data representing: the priority assigned to each respective freight unit, and the workload estimate.

In some embodiments, the priority may correspond to a sequence in which the respective freight unit is to be processed at the receiving site. The workload estimate may be based at least in part on the priority. In some embodiments, the workload estimate may correspond to an allocation of labor resources to be used for processing the respective freight unit at the receiving site. The priority may be based at least in part on the workload estimate.

In some embodiments, the memory may include instructions that when executed by the processor cause the processor to assign the priority based at least in part on a size of the respective freight unit. In some embodiments, the priority assigned to the respective freight unit may be higher than the priority assigned to another freight unit having a smaller size than the respective freight unit. In some embodiments, the workload estimate may be based at least in part on historical data representing amounts of time previously utilized for processing freight units at the receiving site.

In some embodiments, the system may include a user interface operatively coupled to the processor for providing a dashboard application configured to display at least some of the report data via the user interface.

According to an embodiment, a non-transitory computer-readable medium has stored thereon computer-executable instructions that when executed by a computer cause the computer to access a database holding freight data representing each of a plurality of freight units scheduled to be shipped to a receiving site in a single truck load, assess the freight data using a set of business rules, assign a priority to each of the freight units based at least in part on the assessment of the freight data, calculate a workload estimate representing an amount of time to be allocated for processing all of the freight units at the receiving site based at least in part on the set of business rules, and generate report data representing: the priority assigned to each respective freight unit, and the workload estimate.

In some embodiments, the priority may correspond to a sequence in which the respective freight unit is to be processed at the receiving site. The workload estimate may be based at least in part on the priority. In some embodiments, the workload estimate may correspond to an allocation of labor resources to be used for processing the respective freight unit at the receiving site. The priority may be based at least in part on the workload estimate. In some embodiments, the computer-readable medium may include instructions that when executed by the processor cause the processor to assign the priority based at least in part on a size of the respective freight unit. In some embodiments, the priority assigned to the respective freight unit may be higher than the priority assigned to another freight unit having a smaller size than the respective freight unit. In some embodiments, the workload estimate may be based at least in part on historical data representing amounts of time previously utilized for processing freight units at the receiving site.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram representing an exemplary load of freight;

FIG. 2 is a block diagram representing an overview of an exemplary computer-implemented process for automatically planning the receiving and unloading of freight in accordance with some embodiments;

FIG. 3 depicts an example of a graphical user interface for displaying report data in accordance with some embodiments;

FIG. 4 is a flow diagram of an example of a computer-implemented process for automatically generating report data in accordance with an embodiment;

FIG. 5 depicts an example of a graphical user interface for displaying freight data in accordance with some embodiments;

FIG. 6 is a block diagram of an example of a freight processing system for carrying out one or more embodiments; and

FIG. 7 is a block diagram of an exemplary client-server freight processing environment for implementing one or more embodiments.

### DETAILED DESCRIPTION

According to various embodiments, computer-implemented methods, non-transitory computer-readable media and electronic commerce systems are disclosed for automatically planning for the receiving of freight at a retail store, automatically generating freight unload action plans, and automatically collecting data for quality assurance auditing. A web-based graphical user interface can be used for displaying a list of freight items to be unloaded from a truck, the number of labor hours scheduled and available for unloading the freight and performing other activities, and quality auditing information. The planning, unload action plan and/or quality assurance information may be used, for example, by store managers and other employees for identifying freight being delivered to the store before it is unloaded from the truck, and for allocating labor resources for efficiently unloading and handling the freight after it arrives. In general, such information can be used to identify, prior to receiving the freight, what freight items need to be unloaded, how many hours of labor will be necessary to unload the freight, and/or how many people will be assigned to unload the freight after it arrives.

FIG. 1 is a block diagram representing an example of a load of freight 110. The freight 110 includes one or more boxes and/or pallets of items 102a, 102b, 102c, and/or special items 102d (e.g., promotional, sale, and/or limited availability items) of varying sizes, although it will be understood that the freight may be shipped in other configurations, such as loose items or items packed in shipping containers. Individual items, or packages, cases or pallets of items, may be labeled with identifying information, such as information that can be used to identify the items and/or the destination of the items after they are unloaded (e.g., a department number). The freight 110 is shipped to a retail store, e.g., by truck, where it is subsequently received and unloaded.

FIG. 2 is a block diagram representing an exemplary overview of a computer-implemented process 100 for automatically planning the receiving and unloading of the freight 110 of FIG. 1 at a retail store 120, according to an embodiment. A database 140 stores manifest data 142 (also referred to herein as freight data) representing one or more of the items 102a, 102b, 102c, 102d in the load of freight 110. A server 130, a web browser 122 and/or other client application can access the database 140, or another data storage system (not shown), via communications network 144, 146, 148. The server 130 can be configured to apply a set of business rules 132 to the manifest data 142 for generating report data 124. The business rules 132 may include, for example, a set of rules that define how the manifest data 142 is interpreted and presented to a user (e.g., via a computer-implemented user interface) or another computer-implemented process, such as by sorting and/or filtering the items 102a, 102b, 102c, 102d in the report data 124 according to various characteristics including: number of items per case, number of cases or pallets, item description, department number, pallet items, non-basic freight items, and/or large cube items.

The report data 124 can be transmitted to the web browser 122 via communications network 146. In some embodiments, the web browser 122 executes on a computing device located at the store 120. The manifest data 142 may, in some embodiments, be transmitted via communication network 144, 146, 148 to, and be displayed by, the web browser 122. The web browser 122 can be configured to generate and display the report data 124 to a user via a graphical user interface, such as the example graphical user interface 300 depicted in FIG. 3.

When the freight 110 is shipped by truck from a distribution center to a retail store, the freight manifest data 142 can be generated or generated as the truck is being loaded, as the freight is being shipped, or at any other suitable time (e.g., any time prior to unloading the truck). In some embodiments, the freight manifest data 142 is generated by the distribution center or other entity responsible for shipping the freight. The manifest data 142 represents the types and quantities of items 102a, 102b, 102c, 102d in the load. For example, the manifest data 142 may include information indicating that the freight 110 includes thirty-five cases of athletic socks, twenty-four cases of dry dog food, eight cases of apples, etc. The retail store 120 can receive the manifest 142 in advance of delivery and can use the manifest to plan for receiving and unloading the freight upon arrival. The items 102a, 102b, 102c, 102d may be shipped, for example, in boxes and/or on pallets that are coded such that the store can identify the freight as it is received and determine how the freight should be processed. For instance, some freight may be immediately taken from the receiving dock onto the floor of the store 120, where the coding indicates the store department or location in which the items are to be stocked. Other freight may be temporarily stored in a backroom, according to the business needs of the store 120, for example, product promotions, sales or specials.

A variety of items can be contained within any given freight load. For example, a truck may be loaded with a mix of furniture, groceries, electronics, clothing, household products, etc. The exact mix may depend, for example, on the present and/or forecast inventory needs of each store, and therefore may vary significantly from load to load. For example, the freight may include a mix of general merchandise or groceries 102a, 102b, 102c for inventory replenishment (e.g., freight that is moved directly into stock upon receipt) and special items 102d for promotional events or special sales (e.g., freight that may be held in a back room or warehouse temporarily before being placed into stock, or freight that may be stocked in a designated location within the store, such as a free-standing display or aisle end-cap shelf).

In an embodiment, the store 120 receives the manifest 142 prior to arrival of the truck. The business rules 132 can be used to determine how each of the items 102a, 102b, 102c are to be processed upon receipt at the store 120. Some or all of the items in the freight 110 can be prioritized based on the business rules 132. For example, large boxes or perishable items may have a higher priority than small boxes or certain non-perishable items. In another example, general merchandise or groceries 102a, 102b, 102c may have a higher priority than special merchandise 102d. The priority information can be transmitted to the store 120 as part of the report data 124 and used by the store for planning purposes. During the receiving process, the store 120 may use the priority information to determine, for example, the order in which the items 102a, 102b, 102c, 102d are to be unloaded from the truck and moved either directly onto the floor or into a backroom for storage. The priority information may also be used to identify exceptions, that is, items that are to be specially handled (e.g., promotional items that are to be stocked in a different location than non-promotional items of the same type). In some embodiments, labels affixed to each unit of freight can be used to visually identify the contents of the freight and correlate such freight with the priority information.

A workload estimate 126 can be automatically calculated based on the items 102a, 102b, 102c, 102d in the manifest 142 and the business rules 132 (e.g., the respective priorities assigned to the items). The workload estimate 126 is an estimate of the number of labor hours that are required to unload and receive the freight 110. The workload estimate 126 may, for example, be calculated at least in part on predetermined labor times included in the business rules. For example, the predetermined labor time for unloading one case of books may be one minute, and therefore if the freight 110 includes thirty-six cases of books, the workload estimate 126 will be at least thirty-six minutes for unloading that portion of the freight. The workload estimate 126 may, for example, depend at least in part on the size, weight and/or quantity of the items to be unloaded and whether the items 102a, 102b, 102c, 102d are shipped loose, boxed or palletized. For instance, items shipped on pallets may be unloaded by fewer workers and/or in less time than boxed or loose items. Further, heavier or larger items may take more time to unload than lighter or smaller items. The preceding examples are intended to be non-limiting factors that may be used at least in part to calculate the workload estimate 126.

In some embodiments, the workload estimate can be calculated based on one or more of the following non-limiting examples; (1) total scheduled labor hours for a given day; (2) average total call-out labor hours (e.g., unavailable scheduled labor hours); based on historical average (e.g., over the most recent six weeks); (3) total labor break time; (4) available time remaining after accounting for labor call-outs, breaks and/or other scheduled hour reductions; (5) total labor time required to perform various backroom activities; (6) total labor time required to perform various sales floor activities; (7) hours required to complete tasks associated with receiving replenishment freight; and (8) hours required to complete tasks associated with receiving non-replenishment freight (e.g., special freight or large freight).

Various factors used to calculate the workload estimate, some examples of which are listed above, can be based on the set of predetermined business rules 132, the freight manifest data 142, or a combination thereof.

The workload estimate 126 can include the number of labor hours scheduled by the store 120 during the period of time in which the freight 110 is to be unloaded as well as the number of estimated labor hours for performing certain tasks, such as unloading and receiving freight. For example, if the freight is to be unloaded between the hours of 11 PM and 5 AM, and fifty employees are scheduled to work during those six hours, then the number of scheduled hours is 300. If the workload estimate 126 is, for example, 150 hours, then the store 120 can use this information to anticipate that half of the scheduled hours are to be allocated for receiving the freight 110, and may use this information for planning purposes prior to arrival of the freight.

One example of a graphical user interface 300 for displaying a report containing the workload estimate 126 is depicted in FIG. 3 at 310. In this example, the workload estimate as displayed via the user interface 300 may contain the total scheduled labor time and break-downs of the estimated labor time for performing certain activities, such as unloading basic freight (e.g., including items for replenishing stock) and unloading feature freight (e.g., including special items, such as seasonal or limited-quantity goods). Further, the workload estimate 126 may be calculated based on how much of the scheduled time is estimated to be allocated to non-labor activities, such as breaks, meetings and call-outs (e.g., including employees who do not work all or part of their scheduled shifts). The workload estimate 126 may be further divided into different types of activities, such as sales floor activities and backroom activities. In this manner, different workload estimates can be generated for groups of tasks that each share at least some common labor resources. Also depicted in the graphical user interface 300 are buttons for selecting a general merchandise unload action plan 320 and a grocery unload action plan 330 (e.g., unload action plans can be generated for both general merchandise in the freight and groceries in the freight), such as described below with respect to FIG. 5.

FIG. 4 depicts a flow diagram of an exemplary computer-implemented process 400 for automatically generating report data for use in a graphical user interface, according to an embodiment. Process 400 begins at step 402. At step 404, freight data representing a plurality of freight units is accessed by a processor. The freight units may include, for example, individual items, such as items 102a, 102b, 102c, 102d in FIG. 1, boxes of items, and/or pallets of items scheduled to be shipped to a receiving site (e.g., the retail store 120 of FIG. 1). The freight data can include a plurality of processing codes each corresponding to one or more of the items 102a, 102b, 102c, 120d. At step 406, a priority is assigned to each freight unit based on, for example, the respective processing code and the business rules 132 of FIG. 1. In some embodiments, the priority corresponds to a sequence in which the freight units are to be received, unloaded and/or processed at the receiving site. In some embodiments, the priority corresponds to the size and/or weight of the respective freight units (e.g., larger and/or heavier items may be assigned a higher priority than smaller and/or lighter items).

At step 408, a workload estimate for receiving the freight is calculated based on the processing code for each freight unit, the priority assigned to each freight unit and/or the business rules. The workload estimate may represent, for example, an amount of time (e.g., labor hours) to be allocated for receiving, unloading and/or processing (e.g., identifying, organizing, stocking, etc.) all of the freight units at the receiving site. At step 410, a report is generated by the processor. The report can include report data representing the priority assigned to each freight unit and/or the workload estimate. In some embodiments, the workload estimate can be based on historical data representing amounts of time (e.g., labor hours) previously utilized for receiving, unloading and/or processing the freight at the receiving site. For example, if a particular type of freight has historically needed 20 minutes to unload at the receiving site, the workload estimate may be based at least in part on this historical value. In another example, the workload estimate may be based at least in part on a historical average number of employees who do not work their scheduled shifts (e.g., call-outs), the average amount of time allocated to work breaks and meetings, and/or other appropriate factors. Process 400 ends at step 412.

In some embodiments, at step 414, a dashboard, web page or other graphical user interface is rendered (e.g., via a web browser or other user interface). The dashboard can be configured to display the report. One example of such a dashboard is depicted and described above with respect to FIG. 3.

FIG. 5 depicts one example of a graphical user interface 500 that can be used to implement exemplary embodiments described herein. The user interface 500 can be configured to display freight data, e.g., an unload action plan, including one or more freight units (e.g., loose items, boxed items, palletized items) of freight to be unloaded. The unload action plan can be generated based on at least the freight manifest data 142 and/or the business rules 132, and can include a list of the freight items 102a, 102b, 102c, 102d. For instance, the user interface 500 may be configured to display the list of freight items 102a, 102b, 102c, 102d in a particular order according to the unload action plan such that items toward the beginning of the list are to be unloaded before items toward the end of the list. The unload action plan may be printed as a hard copy for reference by employees who are performing the physical handling of the received freight 110. In this manner the unload action plan is advantageous for easily and immediately identifying the contents of the freight 110 and the order in which the freight 110 is to be unloaded from the truck, since sometimes the contents of a box or pallet may not be visually evident until the box or pallet is opened or broken down, a task that may require additional time and labor resources. The unload action plan may also be advantageous for enabling labor resources to be assigned to unloading particular items of the freight 110, as listed in the unload action plan. The unload action plan may have the further advantage of enabling the labor resources unloading the freight 110 to easily identify where the unloaded items 102a, 102b, 102c, 102d are to be placed in the store after they are unloaded from the truck.

One or more unload action plans can be generated for different types of freight, for example, general merchandise and grocery freight. Within each unload action plan, the freight can be filtered and/or grouped by, for example, type or category. For example, the freight can be filtered based on one or more business rules that may be used to identify key freight and replenishment freight. The user interface 500 may display, for example, a description of each freight unit, the department each item in the freight unit is to be stocked in, an item number (e.g., a stock-keeping unit (SKU) number or a manufacturer item number), and/or a quantity of units in the freight, as indicated at 510a, 510b, 510c and 510d. The user interface 500 can be used by the store 120 to plan for the labor resources needed to unload the freight 110 and/or to identify particular items contained within the freight 110, such as special freight or non-replenishment freight. In some embodiments, the under interface 500 can display a priority associated with one or more of the freight units 510a, 510b, 510c, 510d. The unload action plans, for example, can be used by management personnel to plan activities, scheduling of labor resources, and to identify the contents of the freight 110 without having to visually inspect the freight 110.

FIG. 6 is a block diagram of a freight processing system configured in an exemplary computing device 1000 that may be used to implement exemplary embodiments described herein. In some embodiments, the computing device 1000 is included in a retail point of sale terminal, back office system and/or other computing resource. The computing device 1000 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 1006 included in the computing device 1000 may store non-transitory computer-readable and computer-executable instructions or software for implementing exemplary embodiments, such as process 400 of automatically generating report data. The computing device 1000 also includes configurable and/or programmable processor 1002 and associated core 1004, and optionally, one or more additional configurable and/or programmable processor(s) 1002a and associated core(s) 1004a (for example, in the case of computer systems having multiple processors/cores), for executing non-transitory computer-readable and computer-executable instructions or software stored in the memory 1006 and other programs for controlling system hardware. Processor 1002 and processor(s) 1002a may each be a single core processor or multiple core (1004 and 1004a) processor.

Virtualization may be employed in the computing device 1000 so that infrastructure and resources in the computing device may be shared dynamically. A virtual machine 1014 may be provided to handle a process running on multiple processors so that the process appears to be using only one computing resource rather than multiple computing resources. Multiple virtual machines may also be used with one processor.

Memory 1006 may include a computer system memory or random access memory, such as DRAM, SRAM, EDO RAM, and the like. Memory 1006 may include other types of memory as well, or combinations thereof. Memory 1006 may be used to store information such as manifest data 142, business rules 132, report data 124 and/or any other information.

A user may interact with the computing device 1000 through a visual display device 1018, such as a computer monitor or touch screen display integrated into the computing device 1000, which may display one or more user interfaces 1020 (e.g., the user interface 126 of FIG. 1) that may be provided in accordance with exemplary embodiments. The computing device 1000 may include other I/O devices for receiving input from a user, for example, a keyboard or any suitable multi-point touch interface 1008, a pointing device 1010 (e.g., a mouse). The keyboard 1008 and the pointing device 1010 may be coupled to the visual display device 1018. The computing device 1000 may include other suitable conventional I/O peripherals.

The computing device 1000 may also include one or more storage devices 1024, such as a hard-drive, CD-ROM, or other non-transitory computer-readable media, for storing data and non-transitory computer-readable instructions and/or software that implement exemplary embodiments described herein. The storage devices 1024 may be integrated with the computing device 1000. The computing device 1000 may communicate with the one or more storage devices 1024 via a bus 1035. The bus 1035 may include parallel and/or bit serial connections, and may be wired in either a multi-drop (electrical parallel) or daisy-chain topology, or connected by switched hubs, as in the case of USB. Exemplary storage device 1024 may also store one or more databases 1026 for storing any suitable information required to implement exemplary embodiments. For example, exemplary storage device 1024 can store one or more databases 1026, including, for example, the database 140 of FIG. 1, for storing information, such as manifest data 142, business rules 132, report data 124 and/or any other information. The storage device 1024 can also store an engine 1030 including logic and programming for generating the report data, including the workload estimate, general merchandise unload action plan and/or grocery unload action plan, and for performing one or more of the exemplary methods disclosed herein.

The computing device 1000 can include a network interface 1012 configured to interface via one or more network devices 1022 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 1012 may include a built-in network adapter, network interface card, PCMCIA network card, card bus network adapter, wireless network adapter, USB network adapter, modem or any other device suitable for interfacing the computing device 1000 to any type of network capable of communication and performing the operations described herein. Moreover, the computing device 1000 may be any computer system, such as a point of sale terminal (employee-assisted register and/or customer self-service kiosk), workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 1000 may run any operating system 1016, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 1016 may be run in native mode or emulated mode. In an exemplary embodiment, the operating system 1016 may be run on one or more cloud machine instances.

FIG. 7 is a block diagram of an exemplary network environment 1100 suitable for a distributed implementation of exemplary embodiments of a freight processing system, methods and non-transitory computer-readable media. The network environment 1100 may include one or more servers 1102 and 1104, one or more clients 1106 and 1108, and one or more databases 1110 and 1112, each of which can be communicatively coupled via a communication network 1114, such as the network 120 of FIG. 1. The servers 1102 and 1104 may take the form of or include one or more computing devices 1000a and 1000b, respectively, that are similar to the computing device 1000 illustrated in FIG. 6. The clients 1106 and 1108 may take the form of or include one or more computing devices 1000c and 1000d, respectively, that are similar to the computing device 1000 illustrated in FIG. 6. For example, clients 1106 and 1108 may include mobile user devices. Similarly, the databases 1110 and 1112 may take the form of or include one or more computing devices 1000e and 1000f, respectively, that are similar to the computing device 1000 illustrated in FIG. 6. While databases 1110 and 1112 have been illustrated as devices that are separate from the servers 1102 and 1104, those skilled in the art will recognize that the databases 1110 and/or 1112 may be integrated with the servers 1102 and/or 1104 and/or the clients 1106 and 1108.

The network interface 1012 and the network device 1022 of the computing device 1000 enable the servers 1102 and 1104 to communicate with the clients 1106 and 1108 via the communication network 1114. The communication network 1114 may include, but is not limited to, the Internet, an intranet, a LAN (Local Area Network), a WAN (Wide Area Network), a MAN (Metropolitan Area Network), a wireless network, an optical network, and the like. The communication facilities provided by the communication network 1114 are capable of supporting distributed implementations of exemplary embodiments.

In exemplary embodiments, one or more client-side applications 1107 may be installed on client 1106 and/or 1108 to allow users of client 1106 and/or 1108 to access and interact with a multi-user service 1032 installed on the servers 1102 and/or 1104. For example, the users of client 1106 and/or 1108 may include users associated with an authorized user group and authorized to access and interact with the multi-user service 1032. In some embodiments, the servers 1102 and 1104 may provide client 1106 and/or 1108 with the client-side applications 1107 under a particular condition, such as a license or use agreement. In some embodiments, client 1106 and/or 1108 may obtain the client-side applications 1107 independent of the servers 1102 and 1104. The client-side application 1107 can be computer-readable and/or computer-executable components or products, such as computer-readable and/or computer-executable components or products for presenting a user interface for a multi-user service. One example of a client-side application is a web browser configured to display a web page containing the report data 124 and/or the workload estimate 126, the web page being hosted by the server 1102 and/or the server 1104, which may provide access to the multi-user service. Another example of a client-side application is a mobile application (e.g., a smart phone or tablet application) that can be installed on client 1106 and/or 1108 and can be configured and/or programmed to access a multi-user service implemented by the server 1102 and/or 1104. The servers 1102 and 1104 can also provide one or more engines 1034, 1036 including logic and programming for receiving the manifest data 142 and/or the business rules 132 and generating the report data 124, 134 based on the manifest data and business rules, for performing one or more of the exemplary methods disclosed herein.

The databases 1110 and 1112 can store user information, manifest data, report data and/or any other information suitable for use by the multi-user service 1032. The servers 1102 and 1104 can be programmed to generate queries for the databases 1110 and 1112 and to receive responses to the queries, which may include information stored by the databases 1110 and 1112.

Having thus described several exemplary embodiments of the disclosure, it is to be appreciated various alterations, modifications, and improvements will readily occur to those skilled in the art. Accordingly, the foregoing description and drawings are by way of example only.

What is claimed is:

1. A computer-implemented method of processing freight data, the computer including a processor, the method comprising:
electronically accessing a database holding freight data representing each of a plurality of freight units scheduled to be shipped to a receiving site in a single truck load;
electronically assessing the freight data using a set of business rules;
electronically assigning a priority to each of the freight units based the assessment of the freight data;
electronically calculating a workload estimate representing an amount of time to be allocated for processing all of the freight units at the receiving site based on the set of business rules; and
electronically generating report data representing:
the priority assigned to each respective freight unit; and
the workload estimate.

2. The computer-implemented method of claim 1, further comprising assigning the priority based on a sequence in which the respective freight unit is to be processed at the receiving site, and further calculating the workload estimate based on the priority.

3. The computer-implemented method of claim 1, further comprising calculating the workload estimate based on an allocation of labor resources to be used for processing the respective freight unit at the receiving site, and further assigning the priority based on the workload estimate.

4. The computer-implemented method of claim 1, wherein the step of assigning the priority further comprises assigning the priority based on a size of the respective freight unit.

5. The computer-implemented method of claim 4, wherein the priority assigned to the respective freight unit is higher than the priority assigned to another freight unit having a smaller size than the respective freight unit.

6. The computer-implemented method of claim 1, wherein the workload estimate is further based on historical data representing amounts of time previously utilized for processing freight units at the receiving site.

7. The computer-implemented method of claim 1, further comprising providing an application configured to display at least some of the report data via a user interface.

8. A freight processing system comprising:
a programmable processor; and
a memory operatively coupled to the processor, the memory having stored thereon computer-executable instructions that when executed by the processor cause the processor to:
access a database holding freight data representing each of a plurality of freight units scheduled to be shipped to a receiving site in a single truck load, the database being operatively coupled to the processor;
assess the freight data using a set of business rules;
assign a priority to each of the freight units based on the assessment of the freight data;
calculate a workload estimate representing an amount of time to be allocated for processing all of the freight units at the receiving site based on the set of business rules; and
generate report data representing:
the priority assigned to each respective freight unit; and
the workload estimate.

9. The system of claim 8, wherein the priority corresponds to a sequence in which the respective freight unit is to be processed at the receiving site, and wherein the workload estimate is based on the priority.

10. The system of claim 8, wherein the workload estimate corresponds to an allocation of labor resources to be used for processing the respective freight unit at the receiving site, and wherein the priority is based on the workload estimate.

11. The system of claim 8, wherein the memory further comprises instructions that when executed by the processor cause the processor to assign the priority based on a size of the respective freight unit.

12. The system of claim 11, wherein the priority assigned to the respective freight unit is higher than the priority assigned to another freight unit having a smaller size than the respective freight unit.

13. The system of claim 8, wherein the workload estimate is further based on historical data representing amounts of time previously utilized for processing freight units at the receiving site.

14. The system of claim 8, further comprising a user interface operatively coupled to the processor for providing a dashboard application configured to display at least some of the report data via the user interface.

15. A non-transitory computer-readable medium having stored thereon computer-executable instructions that when executed by a computer cause the computer to:
access a database holding freight data representing each of a plurality of freight units scheduled to be shipped to a receiving site in a single truck load;
assess the freight data using a set of business rules;
assign a priority to each of the freight units based on the assessment of the freight data;
calculate a workload estimate representing an amount of time to be allocated for processing all of the freight units at the receiving site based on the set of business rules; and
generate report data representing:
the priority assigned to each respective freight unit; and
the workload estimate.

16. The computer-readable medium of claim 15, wherein the priority corresponds to a sequence in which the respective freight unit is to be processed at the receiving site, and wherein the workload estimate is based on the priority.

17. The computer-readable medium of claim 15, wherein the workload estimate corresponds to an allocation of labor resources to be used for processing the respective freight unit at the receiving site, and wherein the priority is based on the workload estimate.

18. The computer-readable medium of claim 15, further comprising instructions that when executed by the processor cause the processor to assign the priority based on a size of the respective freight unit.

19. The computer-readable medium of claim 18, wherein the priority assigned to the respective freight unit is higher than the priority assigned to another freight unit having a smaller size than the respective freight unit.

20. The computer-readable medium of claim 15, wherein the workload estimate is further based on historical data representing amounts of time previously utilized for processing freight units at the receiving site.
